(19) United States
(12) Patent Application Publication
(10) Pub. No.: US 2017/0023765 A1
(43) Pub. Date: Jan. 26, 2017

(54) PORTABLE VISUALIZATION DEVICES

(71) Applicant: Instinctive Behavior, LLC, Wildwood, MO (US)

(72) Inventor: Scott J. Chasin, Wildwood, MO (US)

(21) Appl. No.: 15/218,665

(22) Filed: Jul. 25, 2016

Related U.S. Application Data
(60) Provisional application No. 62/196,754, filed on Jul. 24, 2015.

(51) Int. Cl. G02B 7/182; G02B 5/08

(52) U.S. Cl. CPC G02B 7/1824; G02B 5/08

(57) ABSTRACT

A portable, soft, enhanced visualization device with a shatterproof reflective surface, dimensioned for use in connection with close-in visualization. The device permits flexible alignment of the reflective surface with a desired line of visualization. Mated components of the device are resistant to coming apart under normal use, but readily assemble and disassemble, has a stable catamaran-style base, and a ledge to rest a smartphone upon.

### CROSS-REFERENCE TO RELATED APPLICATIONS:

This application claims the benefit of U.S. Provisional Patent Application Ser. No. 62/196754, filed Jul. 24, 2015, which is hereby incorporated herein by reference.

STATEMENT REGARDING FEDERALLY SPONSORED RESEARCH OR DEVELOPMENT

Not Applicable

### BACKGROUND OF THE INVENTION:

The subject matter described herein relates generally to reflective surfaces incorporated into shaped portable objects for enhanced viewing, and in particular, to such devices which are soft, shatterproof and shaped to be manipulated either individually or in combination to provide for easy visualization of the human body in otherwise hard-to-visualize locations, and especially, to enhance the intimate experiences of close human interactions.

Throughout the ages, people have been placed in situations where they have been frustrated by the inability to adequately visualize portions of their bodies and/or those in close proximity. These include everything from more easily viewing sores or wounds on their own underside, to aiding themselves in backside grooming, and perhaps most in need, to being able to enjoy fulfilling views of their most intimate moments.

Standing on a bathroom vanity is inherently dangerous. Having appropriate access to a large mirror is often impractical (and frequently also dangerous to maneuver around). Currently, the capability of combining mirrors to access ideal angles is, realistically, non-existent.

What is needed, therefore, is an enhanced visualization device, systems and methods which provide safe, substantially shatterproof surfaces incorporated into various soft, shaped portable and readily manipulated objects, adjustable for enhanced close-up viewing at various angles and positions. In particular, such devices which may be easily manipulated either individually or in combination to provide for visualization of the human body in otherwise hard-to-observe locations, and especially to enhance the intimacy of up-close human interactions.

Thus, the present invention is intended to address this longstanding need and provide other substantial benefits related herein.

### SUMMARY OF THE DISCLOSURE

Accordingly, portable devices, systems and methods which serve as an aid to close up viewing, especially for enhanced intimacy, are provided which address the needs and provide the advantages more fully outlined herein.

The viewing and intimacy aids include variously shaped, preferably soft, portable devices that have a built in reflective, essentially shatterproof surface, and which can be manipulated either individually, or in combination, to provide for easy, enhanced close-in visualization, especially of areas of adult intimate interaction. In a first aspect, a portable enhanced visualization device includes a reflective surface, the device being sized to be portable and dimensioned for use in connection with close-in visualization of oneself or another. Further, the reflective surface is or includes a substantially shatterproof material, the reflective surface is incorporated in, embedded in, or attached to the, preferably soft, device, and the device is configured so that the device adjusts to permit flexible alignment of the reflective surface with a desired line of visualization.

In another aspect, a portable enhanced visualization system is provided. The system includes one or more portable enhanced visualization devices comprising a reflective surface, with the device being sized to be portable and dimensioned for use in connection with close-in visualization of oneself and/or other. The reflective surface is or includes a substantially shatterproof material. The reflective surface is incorporated in, embedded in, or attached to the, preferably soft, device. Further, the reflective surface adjusts to permit flexible alignment of the reflective surface with a desired line of visualization for obtaining intimate viewing.

In a further aspect, a method of close-in intimate viewing is provided. The method includes the use of one or more portable enhanced visualization devices. The one or more devices include a reflective surface, and the device is sized to be portable and dimensioned for use in connection with close-in visualization of oneself or another, wherein the reflective surface comprises a substantially shatterproof material, the reflective surface is incorporated in, embedded in, or attached to the, preferably soft, device, and the reflective surface adjusts to permit flexible alignment of the reflective surface with a desired line of visualization for obtaining intimate viewing.

In additional aspects of the invention, the intimacy aids may include extensions to triangular, or other, shaped pads or extenders, e.g., to connect between components or to elongate horizontally and/or to raise vertically a reflective viewing aid off the floor. In a preferred embodiment, the components of the system have a friction fit, adapted to be resistant to coming apart, but which allow for ready assembly and disassembly when urged by applying a sufficient amount of force to overcome the natural resistance. Other embodiments may include, e.g., notches, handles straps or protrusions, for ease of handling, adjustability functionalities for rapidly aligning the viewing angles on the viewing aids, and an exterior protruding or indented rim or ledge, e.g., for placement of objects and accessories such as smartphones or other appropriately sized recording devices.

### BRIEF DESCRIPTION OF THE DRAWINGS:

The presently disclosed subject matter will be better understood from reading the following description of non-limiting embodiments, with reference to the attached drawings, wherein below:

FIG. 1 is a front perspective view of an embodiment of a soft, portable viewing device in accordance with an exemplary embodiment of the present invention.

FIG. 2 is a top/bottom view of the soft device shown in FIG. 1.

FIG. 3 is a front view of the soft device shown in FIG. 1.

FIG. 4 is a side view of the soft device shown in FIG. 1.

FIG. 5 is a back view of the soft device shown in FIG. 1, highlighting the male/female connectors to the extender as exemplified in FIG. 8(a).

FIG. 6 is a back perspective view of the soft device shown in FIG. 1.

FIG. 7 is a perspective view of the soft device shown in FIG. 1, disassembled into its parts, including a reflective surface or mirror and its soft frame, and two soft support triangles.

FIG. 8(a), (b), (c), and (d) are front perspective, side, front and back views, respectively, of the component which includes the reflective surface or mirror shown within its frame, standing alone apart from the soft triangular supports, of the device shown in FIG. 1.

FIG. 9(a) and (b), are side perspective, side, and top views, respectively, of one of the soft triangular support components, standing alone, of the device shown in FIG. 1.

### DETAILED DESCRIPTION OF THE INVENTION

The foregoing summary, as well as the following detailed description of certain embodiments will be better understood when read in conjunction with the appended drawings. As used herein, an element or step recited in the singular and preceded with the word “a” or “an” should be understood as not excluding the plural of said elements or steps, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

As used herein, the term “soft” when applied to a material or device generally indicates a material or device which, in significant part and under normal conditions is squeezable, cushiony, spongy and compressible yet retracts rapidly and will fully recover its original dimensions.

Accordingly, systems, devices and methods which serve as aids to close up visualization, especially for enhanced intimacy, are provided which address the needs and provide the advantages outlined herein. The viewing and intimacy aids include cushions, furniture and other devices comprising variously shaped, comfortably handled, portable objects that have a built-in reflective, substantially shatterproof surface, and which can be manipulated either individually, or in combination, to provide for safe, easy, enhanced close-in visualization.

Various embodiments as described and shown herein provide a safe device, system and method for individuals to readily and conveniently achieve close-in viewing of themselves and/or themselves and others. As developed by applicant, these safe, soft, essentially shatterproof viewing devices include appropriate reflective surfaces incorporated into shaped cushions or the like, readily adjustable to provide sightlines not previously enjoyed. In various embodiments, the system can include the provision of auxiliary pads configured for use with the portable, manipulable, reflective devices for their extension, and to provide further comfort, alternative configurations and more viewing options. For example, in certain embodiments, the system provides for extenders, extensions to triangular, rectangular, or other shaped pads or cushions adapted for ready attachment to and/or in combination with the portable viewing devices, e.g., to elongate horizontally and/or raise vertically a reflective viewing aid off the floor, or to provide yet additional options for visualization.

In one embodiment, as detailed herein, a cushioned, framed reflective surface, made of soft, pliable silicone or silicone-like material, is provided with triangular supports made of the same or similar material. In this embodiment, the device is constructed to be assembled and disassembled in seconds with friction fit joinders so that the mirror's angles of reflection are infinitely adjustable by the user(s).

In alternative embodiments, the portable, close-in viewing system may include, on the main viewing devices and the auxiliary pads, e.g., notches, handles, or protrusions shaped for ease and sureness of handling. They also are designed with various adjustability functionalities for aligning the viewing angles on the viewing aids. The adjustability of these systems is designed so that viewing angles may be quickly changed “on the fly” as the system is in use. Further, in yet additional embodiments, an exterior ledge, ridge, protrusion or other secure placement mechanism is provided such as for holding or placement of desired objects sized for convenience of the user such as smartphones or other recording devices.

In yet additional embodiments, one or more of the triangle or otherwise shaped support segments has openings in its flanks to allow for extra light for various requirements including aiding in the quality of the reflected image. Other possible features of the system include handles, cut outs and protrusion or projection points in the padding components for wrapping around, grasping with, or laying alongside legs, thighs, hands, and fingers. In still other embodiments, sprockets and notches for incremental movements and adjustments may be provided separately, or in various combinations.

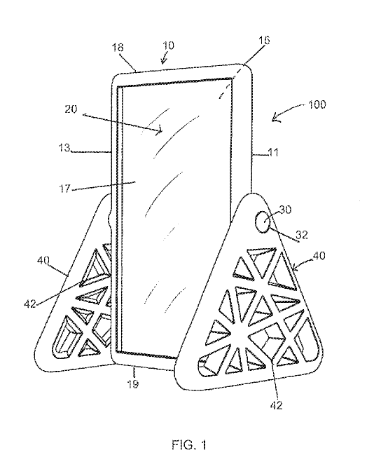

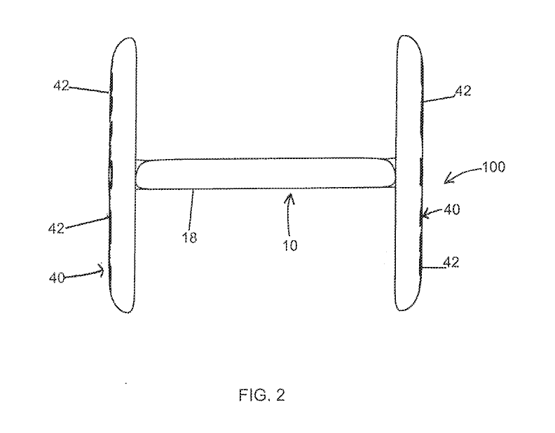

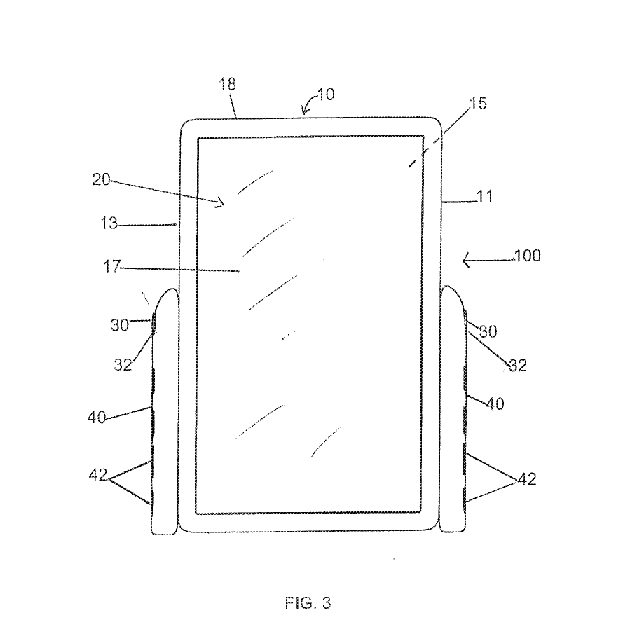

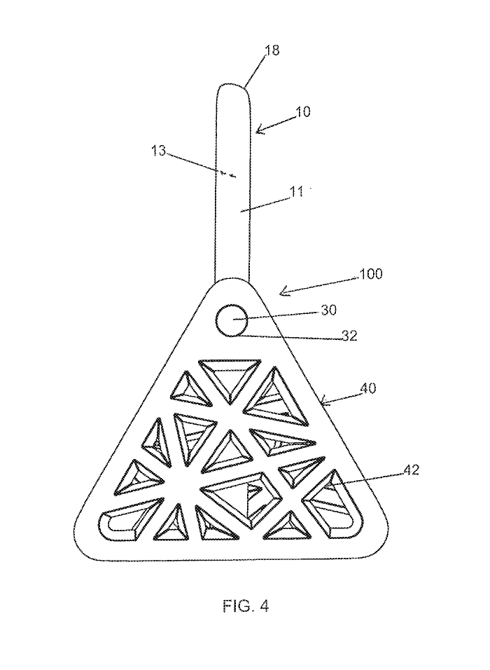

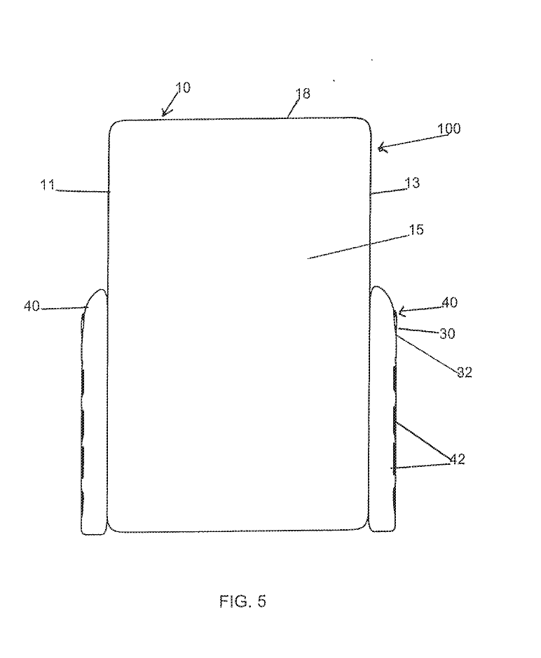

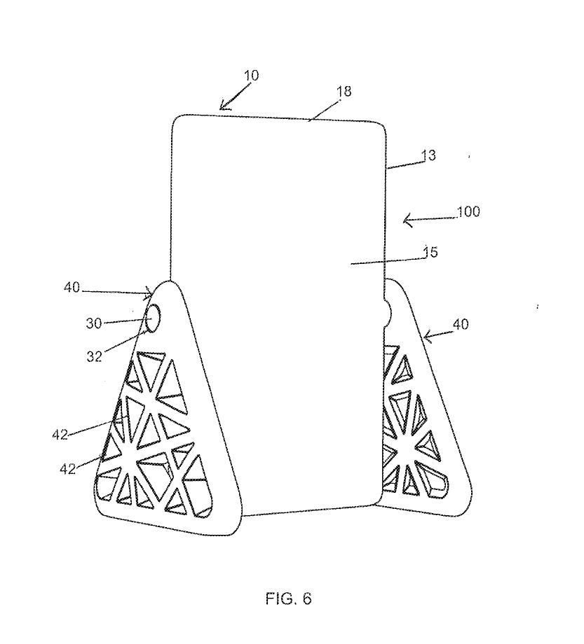

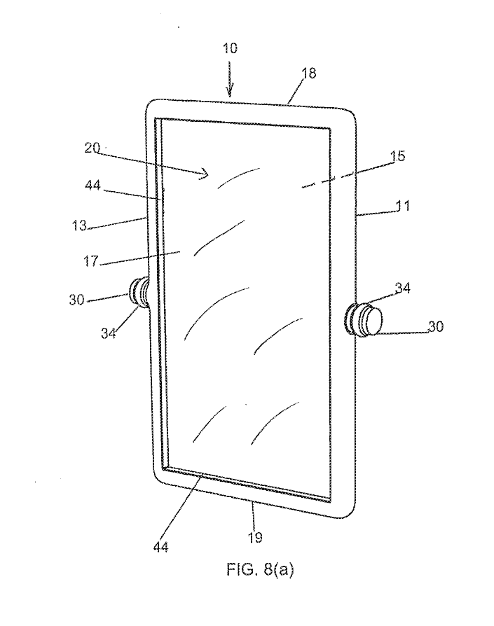

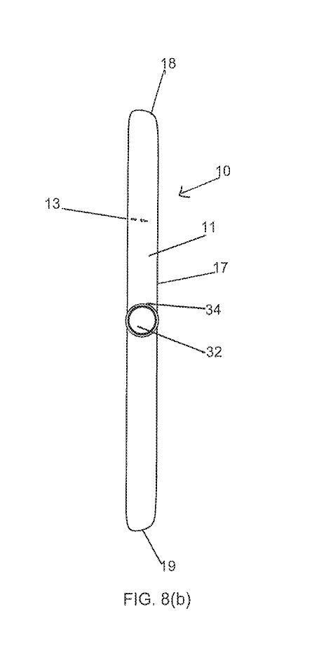

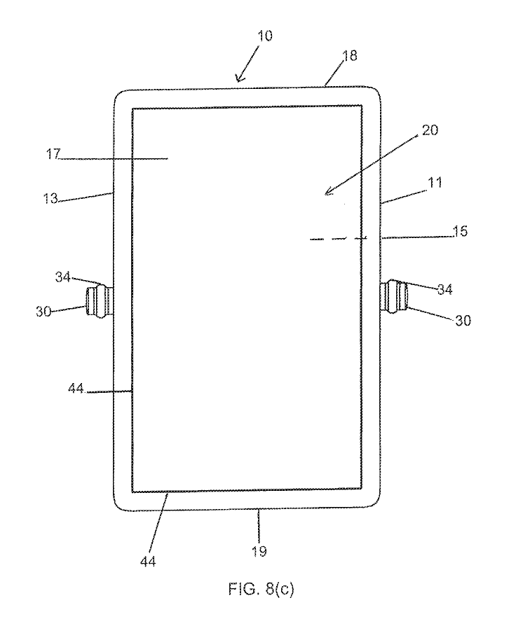

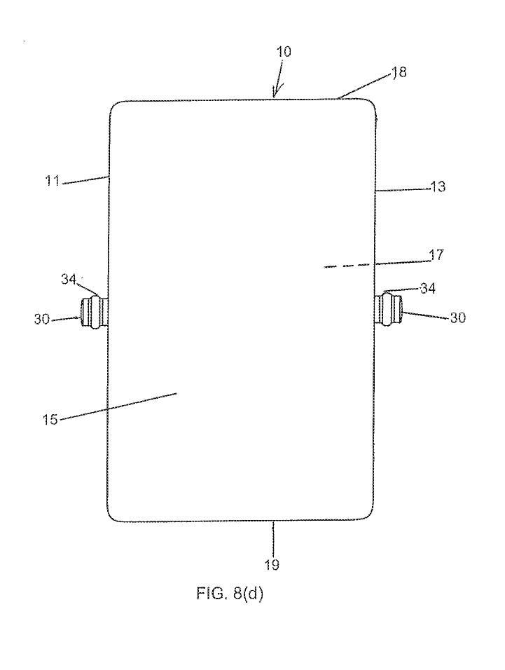

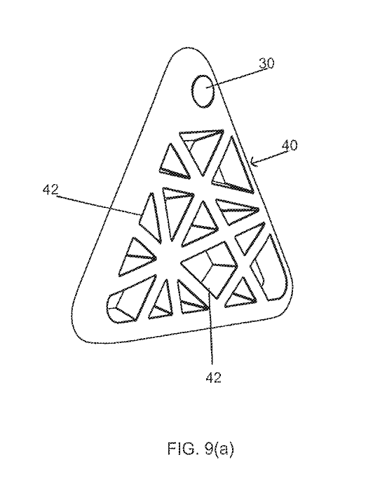

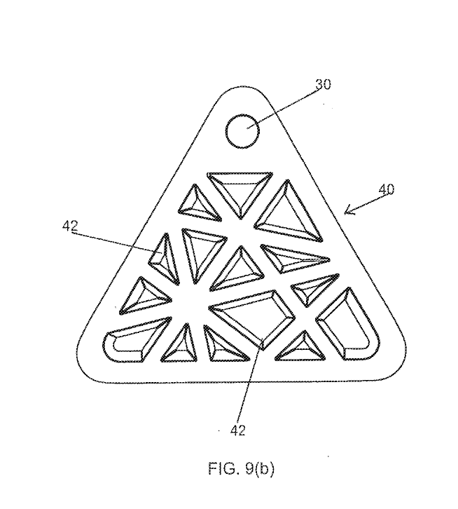

Accordingly, referring to the drawings, in one embodiment of the invention, a cushioned, portable viewing device 100 and its components may be seen as shown (see FIGS. 1-9).

In this exemplary embodiment, the portable viewing device 100 includes a soft frame 10, to which is attached, embedded, incorporated, affixed, etc., a reflective surface or mirror 20. The frame has a first side 11, a second side 13, a back 15, and a front 17, a top 18, and a bottom 19. The reflective surface can be affixed, embedded, attached, etc., to the front 17 of the frame 10 by any conventional means known to those skilled in the art, such as by use of adhesives or appropriate fasteners designed for safety and durability. In one embodiment, see FIG. 1, the edges (11, 13, 18 and 19) are made of silicone or similar material, and are soft, curved and pliant, while resilient, durable and flexible.

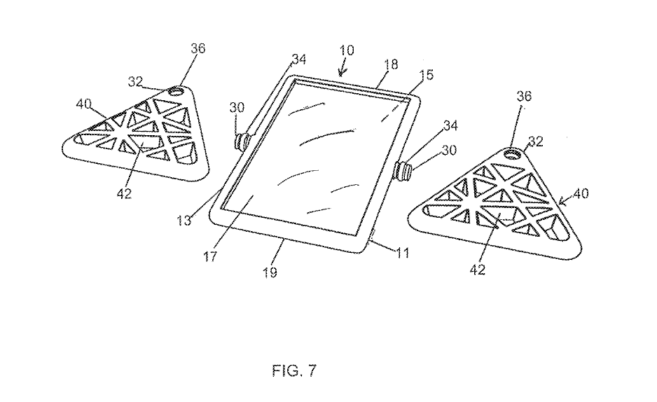

As can best be seen in FIG. 7, showing the device of FIG. 1 as it looks disassembled, in this embodiment, the frame 10 has protrusions or nodes 30 spaced on the frame 10 so that when it is in an upright position the protrusions 30 align with holes or receptors 32 of two soft support triangles 40 made of a material with sufficient give so that when the protrusions or nodes 30 of the mirror frame 10 are pushed into the holes 32 of the two support triangles 40 they are aligned with the holes 32, and the protrusions 30 push or pop into the holes 32, creating a sturdy friction fit. In this embodiment, the protrusions 30 have a ridge 34, and the receptors 32 have a mated dip or trench line 36, which creates an enhanced resistance to the triangle supports 40 pulling apart from the protrusions 30 on the frame 10. However, the device is configured so that the resistance to pulling apart is not so great that freeing the frame 10 from its supports 40 can readily be achieved when making a good tug. This provides the additional benefit that the device can both be assembled and put together for use or disassembled to be conveniently stored away in a matter of seconds. In this embodiment, especially where the frame and support material are made of a sturdy, durable, but soft and flexible material, such as a silicone, the friction fit between the frame 10 and its support triangles 40 is designed to be freely rotatable around the axis created by the interaction of the nodes 30 and holes 32 when they are joined together. However, the fit is resistant enough to movement so that they stay at a chosen angle until another desired angle for viewing is selected and the device is adjusted. Additionally, the friction fit of the described embodiment is strong enough to hold, without difficulty, a smartphone or other video recording device on its ledge, yet still hold its position. In theory, the viewing angles are infinitely adjustable, although something less than 360° will generally suffice in practice.

Also note in the embodiment depicted by, e.g., FIG. 1, the soft triangle supports are reminiscent of a catamaran-style twin base. This configuration allows the device's mirrored portion to easily rest on almost any surface without tipping over or needing to be propped up against another surface or object. As an example of how this enhances the potential use of the device of the invention, imagine a mirror that is capable of resting on an uneven bed comforter, sitting on a step, or resting on even ground, such as outdoors, without being at risk of toppling over.

As described above, in an embodiment as shown in the Figures, the triangle supports include holes 42 in the shape of geometric figures such as triangles, pentagons, etc., which can be grasped and held to manipulate and move the device 100, and, e.g., allow for light to enter behind the device 100.

In another feature, the frame 10 may have a ledge or ridge 44 or, e.g., a cut-out at the bottom, or on one or more available sides. This can serve as a setback to provide added protection to the mirrored surface from being dislodged from the frame. It also can be dimensioned to serve as a shelf to hold objects of use, such as the above-mentioned smartphone/recording device.

Note that given the portability of the visualization devices, the above described orientations of the various components are somewhat arbitrary, as is the general configuration of the device as a rectangular frame having one mirrored surface and two triangular shaped supports. The device 100 can have a reflective surface 20 both front and back (or if shaped more three-dimensionally), on additional fronts. Other configurations of the viewing device, e.g., triangle-shaped solids, parallelograms and multi-sided cushions, of a wide variety of configurations, are also contemplated as within the general teachings of the present invention.

Other features of triangular, rectangular, or other three-dimensional embodiments of the invention include notches to function as handles on the side wall (which, alternatively, may be straps, protrusions or other means for obtaining a firm grasp or quick adjustment of) the portable viewing device.

In another aspect of the system of the invention, extenders can be provided which may be pads, cushions, or similar objects attachable to the visualization devices and which provide for added cushioning and comfort and for additional angles for close-in viewing. In use, the extender may be grasped by notched out handles and/or connectors as located in, e.g., the top and bottom surfaces, which alternatively or additionally could be, e.g., located at the sides, back or front surfaces. As with the visualization devices, in various embodiments the notched out handles may alternatively be handles, protrusions or straps, etc., for ease and sureness of handling, or for better securing multiple components of viewing devices and extenders together. The portable visualization system composed of various combinations of viewing devices and extenders also are designed with various adjustability functionalities for aligning the viewing angles on the viewing aids. The adjustability of the combined system is also designed so that viewing angles may be easily adjusted as the system is in use, yet can take maximum advantage of the added length, width or other dimensional variability provided by the extenders or by the spacing of the combined visualization devices.

Thus, in some embodiments, the viewing or visualization device and one or more extenders may be securely joined together in various configurations, e.g., by use of matching female and male port connectors, respectively, on the viewing device and the extender.

In yet additional embodiments of the extender of the invention, one or more of a side opening in the extender is provided, e.g., to allow for extra light and handles, cut outs and protrusion or projection points in the padding components for wrapping around, grasping with, or laying alongside legs, thighs, hands, and fingers. Similarly, sprockets and notches for incremental movements and adjustments are provided separately, or in various combinations. These may of course be reversed, and the viewing devices 100 and extenders may be attached using other means known to those skilled in the art such as, e.g., hook and loop fasteners, large plastic pegs, etc. In yet further variations, multiple viewing or visualization devices and multiple extenders may be joined together to provide a variety of viewing angles, and cushioned places to lie or rest.

In various embodiments, the portable visualization system and included devices and methods are designed to be utilized for solving the problem of easily and conveniently being able to visualize intimate activities, or otherwise viewing yourself and/or others in normally hard-to-visualize places. Moreover, their usage removes the danger associated with using conventional mirrors in places they are not typically employed. Since the portable viewing device, cushions and pads of the invention contain one or more adjustable, shatterproof acrylic or other reflective surfaces, they can easily and quickly be placed anywhere in order to provide for close-in, and intimate viewing opportunities, without the risk associated with conventional mirrors. And, as noted above, as configured, the use of the viewing devices of the present invention are very safe, as the reflective surfaces are shatterproof and the components of the device such as the frame and supports are soft. Their use is highly portable, flexible, and can quickly be assembled or disassembled and conveniently stored.

In one example, if a couple is in the process of having relations over a mirror that is on the ground, the female participant can only see a limited amount of the interaction due to the fact that her sightline down to the mirror and back up to her partner is at an angle not conducive to effective viewing. With a portable viewing device of the invention below her face and another below her mid-section, and with both mirrors set at approximately 45° angles, the female can now for the first time have a full view of the couple's mid-sections from an angle never before possible. And certainly not with this degree of accuracy, ease, safety and configuration possibilities.

Assuming that a participant does not want to look straight down, using the system of the invention, he or she can place the viewing device more forward, e.g., out in front of one's head, thus changing the angle of the mirrored surface to quickly and easily line up with the other mirror below the point of intimacy. This is but one example of the almost limitless intimate situations which can have their visualizations enhanced.

In certain embodiments, a significant benefit of the use of the system of the invention is its adjustability for visualization enhancement, accuracy and accommodation. If the mirrors or reflective surfaces were locked in at a single, predetermined angle, while possibly providing some benefit, they likely would not provide visualization of the full variety of desired areas or angles, or, some might be made exceedingly more difficult. The adjustability of the portable visualization devices of the invention avoids the user having to prop up the viewing device into certain positions with other nearby objects, making it laborious and/or unstable. By providing the ability for the mirrors or reflective surfaces to be readily angled “in use”, the reflections now follow the user's demands, rather than forcing the user to conform to the constraints of the device's predetermined reflection.

As detailed herein, embodiments of the invention provide the significant benefit that the entire visualization device is “soft”. When using any conventional mirror, there is great risk that the user can suffer scratches and abrasions, not just from the actual mirror, but also from the mirror's frame and supporting structure.

In certain embodiments, the portable cushioned viewing devices and, in certain embodiments, extenders may be, e.g., approximately 4-24, 7-18, or 9-12 inches, end to end. As they might be hard to grab onto with two hands during intimacy or other viewing, and quite difficult to maneuver with only one, the triangle supports may have geometric holes, or in other embodiments, notched out sections, straps, protrusions or the like, added to allow the user to easily grab, manipulate and hold onto.

In certain embodiments, a light, soft, yet strong and resilient foam-like material is used for the bodies of both the portable, cushioned viewing device, including both the frame and supports, and also the extender. This may be a closed-cell and cross-linked material that is waterproof and resistant to both mold and mildew. Additionally, it is chemically resistant and has excellent tensile and tear strength. It is a foam material that, however, unlike many types of foam, is durable and strong. It is soft, yet hard enough to substantially hold the acrylic mirror or other shatterproof or substantially or essentially shatterproof reflective material and allow the device to be dropped on the floor without adverse effects. Additionally, the ideal material is durable and allows for a firm affixation of the reflective material to the frame material. For example, but without limitation, the foam material may be selected from one or more of silicone or silicone-like materials, ethylene vinyl acetate (EVA Foam), polyethylene foam, reticulated polyurethane foam, melamine, molded fiber, rigged, rubber or corrugated plastic, plastics such as PETE, HDPE, PVC, LDPE, PP, PS, polycarbonate, polyactide, synthetic or natural rubber, natural fibers, woods and metals which meet most if not all of the above performance criteria.

The reflective surface material should be substantially, preferably wholly, shatterproof in practical use, and lighter, preferably significantly lighter, than a standard glass mirror surface, while providing approximately equal reflectivity. The reflective surface may have a thickness of between 1/32 and ¾ an inch, preferably 1/16 and ⅗ an inch, more preferably ⅛ and ½ an inch, and most preferably approximately ¼ an inch. The reflective surface may be less than ¾ the weight of a standard glass mirror, preferably less than ½, more preferably less than ¼ the weight and most preferably approximately ten times lighter than a standard glass mirror surface. By example, but without limitation, the reflective surface may comprise one or more of an acrylic mirror, a plexiglass acrylic mirror, plexiglass sheets, glassless mirror, shatterproof glass mirror, reflective aluminum reflector, silvered mirror either clear, ultra-clear, antiqued, concave, convex, or first surfaced, silver tined mirror, silver safety mirror, either tempered, laminated or safety-backed, non-silvered mirror either pyrolytic or transparent/two-way, or any reflective one-way or two-way surface which meet most, if not all of the above-described desired features.

As constructed, the reflective surface or mirror 20 may be adhered to and rest upon the supporting frame or mount 10 integral to or additionally adhered on the front 17 (or alternative surface) of the visualization device 100. In preferred embodiments, this surface, and the general composition of the device in which it is embedded, comprises a flat silicone, or silicone-like foam, or otherwise cushioned material as described above.

In certain embodiments, the visualization device and extenders are joined together using, e.g., male female component friction fits to assist in maintaining their connection. Then, in preferred embodiments, the foam material used is notched (or have alternative grasping means) so that they may be readily grabbed, manipulated and/or held.

Thus, this invention in its various embodiments serves to provide a means for easy visualization of the human body, particularly in close-in intimate situations, using safe, portable, and adjustable devices which allow for sought-after sightlines and viewing angles. Systems employing combinations of such devices are also provided.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the following claims, the terms “first,” “second,” etc., are used merely as labels, and are not intended to impose numerical requirements on their objects.

This written description uses examples to disclose the various embodiments of the invention and also to enable any person skilled in the art to practice the various embodiments of the invention, including making and using any devices or systems and performing any incorporated methods. The patentable scope may include other examples that occur to those skilled in the art. Such other examples are intended to be within the scope of the invention if the examples have structural elements or steps that do not differ from the literal language of the described invention, or if the examples include equivalent structural elements or steps with insubstantial differences from the literal language as set forth herein.

What is claimed is:

1. A portable enhanced visualization device comprising:
A reflective surface;
The device being sized to be portable and dimensioned for use in connection with close-in visualization of oneself or another;
Wherein the reflective surface comprises a substantially shatterproof material;
Wherein the reflective surface is incorporated in, embedded in, or attached to the device; and,
Wherein the device is configured so that the device adjusts to permit flexible alignment of the reflective surface with a desired line of visualization.

2. The device of claim 1 wherein the reflective surface comprises an acrylic mirror.

3. The device of claim 1 wherein the device further comprises a frame for attachment to the reflective surface, one or more supports attachable to the frame, and wherein the frame and supports are connected by friction fit.

4. The device of claim 3 wherein one or both of the frame and the one or more supports comprise a soft material.

5. The device of claim 3 wherein the device is further adapted so that mated components are resistant to coming apart under normal use, but are adapted for ready disassembly when sufficient force to overcome the resistance to coming apart is applied.

6. The device of claim 1 wherein the device attaches to one or more extenders.

7. The device of claim 1 wherein the reflective surface has an adjustable line of visualization comprising a substantially continuous arc.

8. The device of claim 4 wherein the reflective surface has an adjustable line of visualization comprising a substantially continuous arc.

9. The device of claim 3 wherein the one or more supports comprise a catamaran-style twin base.

10. The device of claim 3 wherein the frame has at least one ledge or rim dimensioned for a smartphone or recording device to rest upon.

11. A portable enhanced visualization system comprising one or more portable enhanced visualization devices comprising a reflective surface, said device being sized to be portable and dimensioned for use in connection with close-in visualization of oneself or others, wherein the reflective surface comprises a substantially shatterproof material, wherein the reflective surface is incorporated in, embedded in, or attached to the device, and wherein the reflective surface adjusts to permit flexible alignment of the reflective surface with a desired line of visualization for obtaining intimate viewing.

12. The system of claim 11 comprising at least two portable enhanced visualization devices comprising a reflective surface, said devices being sized to be portable and dimensioned for use in connection with close-in visualization of oneself or others, wherein the reflective surface comprises a substantially shatterproof material, wherein the reflective surface is incorporated in, embedded in, or attached to the device, and wherein the reflective surface adjusts to permit flexible alignment of the reflective surface with a desired line of visualization for obtaining intimate viewing, and wherein the reflective surfaces of the at least two devices are aligned so that the combined reflection provides a desired angle of visualization.

13. The system of claim 11 wherein the one or more supports of at least one of the devices comprise a catamaran-style twin base.

14. The system of claim 11 further comprising one or more extenders.

15. A method of close-in intimate viewing comprising the use of a portable enhanced visualization system comprising one or more portable enhanced visualization devices comprising a reflective surface, said device or devices being sized to be portable and dimensioned for use in connection with close-in visualization of oneself or others, wherein the reflective surface comprises a substantially shatterproof material, wherein the reflective surface is incorporated in, embedded in, or attached to the device, and wherein the reflective surface adjusts to permit flexible alignment of the reflective surface with a desired line of visualization for obtaining intimate viewing.

16. The method of close-in intimate viewing of claim 15 wherein at least one of the visualization devices further comprises a frame for attachment to the reflective surface, one or more supports attachable to the frame, and wherein the frame and supports are connected by friction fit, wherein one or both of the frame and the one or more supports of the at least one of the visualization devices further comprises a soft material, and the at least one of the visualization devices is resistant to coming apart under normal use, but is adapted for ready disassembly when sufficient force to overcome the resistance to coming apart is applied.

17. The method of claim 15 further comprising obtaining the device, positioning the device for viewing of one's body, and adjusting the device to obtain a desired line of visualization.

18. The method of claim 15 further comprising the use of at least two portable enhanced visualization devices comprising a reflective surface, said devices being sized to be portable and dimensioned for use in connection with close-in visualization of oneself or others, wherein the reflective surface comprises a substantially shatterproof material, wherein the reflective surface is incorporated in, embedded in, or attached to the device, and wherein the reflective surface adjusts to permit flexible alignment of the reflective surface with a desired line of visualization for obtaining intimate viewing, and wherein the reflective surfaces of the at least two devices are aligned so that the combined reflection provides a desired angle of visualization.

19. The method of claim 15 further comprising the use of a combination of two or more portable viewing devices, wherein multiple viewing angles are provided for by the combination of portable viewing devices.

20. The method of claim 15 wherein the system is further configured to be readily assembled and disassembled.

21. The method of claim 15 wherein the one or more supports comprise a catamaran-style twin base.
